(19) United States
(12) Patent Application Publication
(10) Pub. No.: US 2009/0059511 A1
(43) Pub. Date: Mar. 5, 2009

(54) DOCK STATION AND MINI-PROJECTOR BEING MUTUALLY INTEGRATED

(75) Inventors: Cheng-Kuo Chu, Tainan County (TW); Yung-Yuan Ho, Tainan County (TW); Tung-Yang Chen, Tainan County (TW)

Correspondence Address: J C PATENTS, INC., 4 VENTURE, SUITE 250, IRVINE, CA, 92618, US

(73) Assignees: HIMAX DISPLAY, INC., Tainan County (TW); HIMAX TECHNOLOGIES LIMITED, Tainan County (TW)

(21) Appl. No.: 11/870,191

(22) Filed: Oct. 10, 2007

(30) Foreign Application Priority Data
Aug. 27, 2007 (TW) 96131679

(51) Int. Cl. G06F 1/16

(52) U.S. Cl. 361/686

(57) ABSTRACT

A dock station and a mini-projector being mutually integrated is provided. The dock station includes a dock station body, a projector interface and a power management unit. The dock station body is employed for connecting at least an electronic apparatus. The projector interface is employed for connecting the mini-projector and the dock station body. The power management unit is disposed in the dock station body. The dock station uses the mini-projector to play AV data in the electronic apparatus.

### CROSS-REFERENCE TO RELATED APPLICATION

This application claims the priority benefit of Taiwan application serial no. 96131679, filed on Aug. 27, 2007. All disclosure of the Taiwan application is incorporated herein by reference.

### BACKGROUND OF THE INVENTION

1. Field of the Invention

The present invention generally relates to a dock station and a mini-projector, and more particularly, to a dock station and a mini-projector being mutually integrated.

2. Description of Related Art

Along with the progress in science and technology, various electronic apparatuses are being developed following the latest trend of high-speed, high-efficiency and light-slim-short-small appearance design. In such a market direction, diverse portable electronic apparatuses have gradually played a major role in the mainstream electronic product market, which are, for example, handset, notebook PC and personal digital assistant (PDA). In order to further compact a portable electronic apparatus for portability, usually, a portable electronic apparatus is designed to cut out some functions in comparison with a regular-sized apparatus. To fill the function gap as mentioned above, a design employing a dock station has emerged recently.

A dock station commonly means a hardware architecture and a set of interfaces for electrical connection. A portable electronic apparatus is able to expand various usages by using a dock station to link other peripheral equipments. However, in terms of available dock stations on the market today, the so-called dock station is mostly limited to charging, connecting a computer and/or sound playing functions, where no projection function is integrated therewith.

In addition, along with the miniature trend and low pricing policy for a projector today, a reasonable development is to integrate a mini-projector into a dock station, which is helpful to share AV data and gain usage convenience.

### SUMMARY OF THE INVENTION

Accordingly, the present invention is related to a dock station to add a projection function to a portable electronic apparatus.

The present invention is also related to a mini-projector suitable to be placed at the above-mentioned dock station so as to expand the usages of the dock station with projection function.

The present invention provides a dock station, which includes a dock station body, a projector interface and a power management unit. The dock station body is employed for connecting at least an electronic apparatus; the projector interface is employed for connecting a mini-projector and the dock station body; the power management unit is disposed in the dock station body, wherein the dock station uses the mini-projector to play audio/video (AV) data in the electronic apparatus.

The present invention provides a mini-projector suitable to be placed on the dock station, and the mini-projector includes a projector body and a rechargeable battery, wherein the projector body is employed for connecting at least an electronic apparatus through the above-mentioned dock station, while the rechargeable battery is disposed in the projector body for providing the projector body with an operation power. The electronic apparatus may be employed to play AV signals by means of the projector body.

By additionally employing a projector interface and a power management unit disposed in the dock station, the present invention makes the dock station have projection function. After linking the dock station with the mini-projector through the projector interface, on one hand, the power management unit is utilized to provide a required operation power; and on the other hand, a user is allowed to conduct projection while recharging the mini-projector for lengthening projection duration. Besides, by additionally disposing a rechargeable battery at the mini-projector, the mini-projector provided by the present invention gains a carriage convenience for conducting a short-coverage projection. Therefore, the present invention provides a great convenience to a user frequently conducting projections without going to a special projection site equipped with projection equipments to do projection jobs.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a dock station according to an embodiment of the present invention.

FIG. 2 is a 3-D diagram of a dock station and a mini-projector according to an embodiment of the present invention.

FIG. 3 is a block diagram of a mini-projector according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

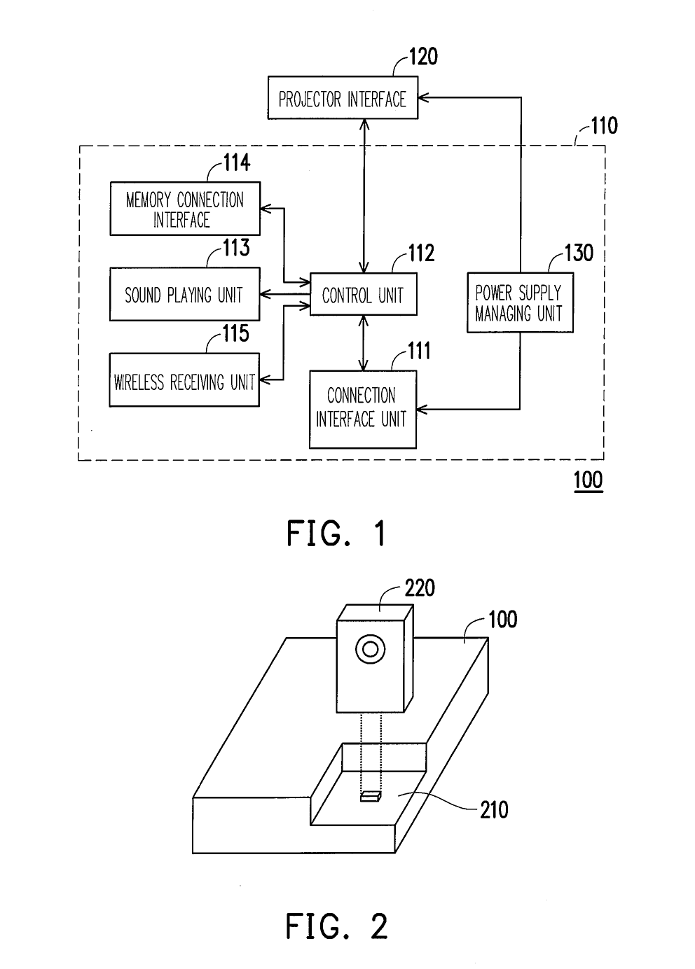

FIG. 1 is a block diagram of a dock station according to an embodiment of the present invention. Referring to FIG. 1, a dock station 100 includes a dock station body 110, a projector interface 120 and a power management unit 130. The dock station body 110 includes a connection interface unit 111, a control unit 112, a sound playing unit 113, a memory connection interface 114 and a wireless receiving unit 115. The projector interface 120 is suitable to connect a mini-projector (not shown) and the dock station body 110 may be employed for transmitting data signals between the mini-projector and the dock station body 110. The power management unit 130 is disposed in the dock station body 110 for charging an electronic apparatus connected to the dock station body 110, and the above-mentioned electronic apparatus is, for example, computer, notebook PC, digital video camera, digital camera, mobile phone, multimedia entertainment device or music player.

The dock station body 110 is suitable to connect various electronic apparatuses, and after the dock station body 110 receives AV data in the electronic apparatus, the AV data is delivered by the projector interface 120 to the mini-projector for playing.

There are various connection interfaces with an electronic apparatus, for example, composite video baseband signal (CVBS) interface, video graphic array (VGA) interface, universal serial bus (USB), mini universal serial bus (MINIUSB) or YPbPr interface. In order to suit the above-mentioned connection interfaces of an electronic apparatus for connecting to the dock station 100, the connection interface unit 111 in the dock station body 110 includes computer link interface, AV interface, handset interface and sound interface for connecting the above-mentioned various electronic apparatuses. The computer link interface is employed for linking computer or notebook PC to transmit data in the computer or the notebook PC.

The AV interface is employed for connecting digital video camera, digital camera or multimedia entertainment device (for example, video game machine) and is suitable for transmitting video data in the digital video camera, digital camera or multimedia entertainment device. The handset interface is for connecting mobile phone and suitable to transmit AV data in the mobile phone to the mini-projector for playing. The sound interface is employed for connecting music player (for example, MP3 player) and is suitable for transmitting AV data stored in the music player. In the present embodiment, a computer link interface can be USB; an AV interface can be composite video baseband signal interface, VGA interface, USB interface, MINIUSB or YPbPr interface, while a sound interface can be USB.

The control unit 112 is coupled between the connection interface unit 111 and the projector interface 120 for processing the operations with regard to transmitting and playing AV data in the electronic apparatus, that is to say after the electronic apparatus is connected to the connection interface unit 111, the AV data stored in the electronic apparatus would be proceeded by the control unit 112 to be converted into signals ready to be played, following by transmitting the above-mentioned signals to the mini-projector through the projector interface 120 for playing, wherein the control unit 112 may be a microprocessor.

The sound playing unit 113 is coupled to the control unit 112 for playing audio data and may be a micro speaker or a loudspeaker. The memory connection interface 114 is coupled with the control unit 112 for linking a memory device, for example, portable hard disk or memory card, while the above-mentioned memory connection interface 114 is, for example, memory card interface or USB. After the AV data stored in the memory device processed by the control unit 112, the AV data is transmitted to the mini-projector for playing through the projector interface 120.

The wireless receiving unit 115 is coupled to the control unit 112 for receiving remote signals emitted by a wireless remoter, and after the remote signal is processed by the control unit 112, a corresponding action would be executed. In this way, a user is able to deliver instructions to the dock station 100 by a remoter, and the electronic apparatus or the mini-projector connected to the dock station 100 would be operated, wherein the wireless receiving unit 115 may include an infrared receiver or a bluetooth module.

In the present embodiment, the dock station 100 further includes a housing cavity 210 embedded therein, in which the projector interface 120 is disposed. As shown by FIG. 2, the housing cavity 210 may be used to accommodate the mini-projector 220. When the mini-projector 220 is placed on the housing cavity 210 of the dock station 100, the power management unit 130 provides the mini-projector 220 with a required operation power, so that a user is allowed to conduct projection while recharging the mini-projector for lengthening projection duration.

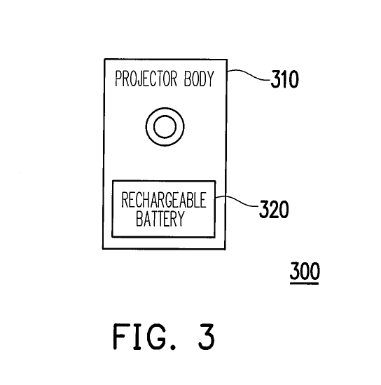

Besides, the present invention provides a mini-projector suitable to be placed at the above-mentioned dock station 100, as shown by FIG. 3. FIG. 3 is a block diagram of a mini-projector according to the embodiment of the present invention. Referring to FIG. 3, a mini-projector 300 includes a projector body 310 and a rechargeable battery 320. The rechargeable battery 320 is disposed in the projector body 310 for providing the projector body 310 with an operation power so as to enable the projector body 310 to have sufficient electricity to independently conduct projection, wherein when the rechargeable battery 320 is electrically consumed away, recharging can be performed through the dock station 100. The projector body 310 is capable of connecting to the electronic apparatus through the dock station 100 for playing AV signals in the electronic apparatus.

The mini-projector 300 is able to be directly connected to the electronic apparatus or integrated into the electronic apparatus, for example, integrated into a handset or other portable electronic apparatuses. When the mini-projector 300 is an independent electronic apparatus, as shown by FIG. 3, the rechargeable battery 320 can be disposed in the mini-projector 300 to directly provide the mini-projector 300 with a required operation power, and at the situation, the rechargeable battery 320 is able to be recharged through the dock station 100 as well. When the mini-projector 300 has no rechargeable battery 320 disposed therein, the mini-projector 300 is able to obtain the required power through the electronic apparatus connected thereto.

In the present embodiment, since the mini-projector 300, the dock station 100 and the electronic apparatus are allowed to be wired in any manner, thus, a user can be provided with a great convenience to manipulate. For a user to conduct projection in a short duration of time any place, the user may carry the mini-projector 300 there to project AV data in the electronic apparatus; for a user to conduct projection in a long duration of time, the user may carry the mini-projector 300 and the dock station 100 to project AV data for a longer time. Besides, the mini-projector 300 may be implemented by using liquid crystal on silicon (LCOS) panel technology for miniaturization purpose.

In summary, the dock station and mini-projector mutually integrated of the present invention has at least following advantages:

(1) By disposing a projector interface in the dock station and connecting the mini-projector to the dock station, the dock station would have the projection function.

(2) By disposing a power management unit in the dock station and connecting the mini-projector to the dock station, the power management unit is able to provide a required operation power and recharge the mini-projector so as to lengthen projection duration.

(3) By disposing a rechargeable battery in the mini-projector, a great convenience for short time projection is achieved.

(4) The dock station and the mini-projector can be conveniently carried, therefore, a user need not necessarily go any special site equipped with projection equipments to conduct projection.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A dock station, comprising:
a dock station body, for connecting at least an electronic apparatus;
a projector interface, for connecting a mini-projector and the dock station body; and
a power management unit, disposed in the dock station body;
wherein the dock station uses the mini-projector to play AV data in the electronic apparatus.

2. The dock station according to claim 1, wherein the power management unit is employed for charging the electronic apparatus.

3. The dock station according to claim 1, wherein the power management unit is employed for charging the mini-projector.

4. The dock station according to claim 1, wherein the mini-projector comprises an liquid crystal on silicon (LCOS) panel.

5. The dock station according to claim 1, wherein the dock station comprises a housing cavity embedded therein to place the mini-projector thereon.

6. The dock station according to claim 1, wherein the mini-projector is integrated into a handheld mobile communication device.

7. The dock station according to claim 1, wherein the mini-projector is integrated into a portable electronic apparatus.

8. The dock station according to claim 1, wherein the electronic apparatus comprises computer, notebook PC, digital video camera, digital camera, mobile phone, multimedia entertainment device or music player.

9. The dock station according to claim 1, wherein the dock station body comprises a connection interface unit for connecting to the electronic apparatus.

10. The dock station according to claim 9, wherein the connection interface unit comprises:
a computer link interface, for linking a computer or a notebook PC;
an AV interface, for connecting a digital video camera, a digital camera or a multimedia entertainment device;
a handset interface, for connecting a mobile phone; and
a sound interface for connecting a music player.

11. The dock station according to claim 10, wherein the AV interface comprises composite video baseband signal (CVBS) interface, video graphic array (VGA) interface, universal serial bus (USB) interface, mini universal serial bus (MINIUSB) or YPbPr interface.

12. The dock station according to claim 10, wherein the sound interface comprises a universal serial bus (USB).

13. The dock station according to claim 10, wherein the computer link interface comprises a universal serial bus (USB).

14. The dock station according to claim 9, wherein the dock station body comprises:
a control unit, coupled between the connection interface unit and the projector interface, for processing AV data transmission;
a sound playing unit, coupled to the control unit; and
a memory connection interface, coupled to the control unit for connecting to least a memory device.

15. The dock station according to claim 14, wherein the dock station body comprises a wireless receiving unit coupled to the control unit for receiving a remote signal.

16. A mini-projector, disposed at the dock station according to claim 1; comprising:
a projector body, for connecting an electronic apparatus via the dock station; and
a rechargeable battery, disposed in the projector body, for providing the projector body with an operation power;
wherein the electronic apparatus uses the projector body to play an AV signal.

17. The mini-projector according to claim 16, wherein the projector body comprises a liquid crystal on silicon (LCOS) panel.

18. The mini-projector according to claim 16, wherein the projector body is integrated into a handheld mobile communication device.

19. The mini-projector according to claim 16, wherein the projector body is integrated into a portable electronic apparatus.

20. The mini-projector according to claim 16, wherein the rechargeable battery is recharged through the dock station.

21. The mini-projector according to claim 16, wherein the electronic apparatus comprises computer, notebook PC, digital video camera, digital camera, mobile phone, multimedia entertainment device or music player.
